(19) United States
(12) Patent Application Publication
(10) Pub. No.: US 2005/0189923 A1
(43) Pub. Date: Sep. 1, 2005

(54) Auxiliary power source device, fixing device, image forming apparatus and charge operation control method

(76) Inventors: Hiroto Ohishi, Kanagawa (JP); Masahide Nakaya, Kanagawa (JP); Naoki Sato, Kanagawa (JP); Keiichi Sugai, Miyagi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/039,865

(22) Filed: Jan. 24, 2005

(30) Foreign Application Priority Data
Jan. 29, 2004 (JP) 2004-021043
Dec. 6, 2004 (JP) 2004-352946

(51) Int. Cl. H02J 7/00

(52) U.S. Cl. 320/138

(57) ABSTRACT

An auxiliary power source device includes: a first battery; a first charger receiving power supply from a commercial power source and charging the first battery; a second battery connected with the first battery in series; a second charger receiving power supply from the commercial power source and charging the second battery; a detecting circuit detecting voltages of the first battery and the second battery; and a control part switching charging operation between the first and second chargers for a final target voltage based on a detection result of the detecting circuit.

### BACKGROUND OF THE INVENTION

1. Field of the Invention

The present invention relates to an auxiliary power source device, a fixing device, an image forming apparatus and a charge operation control method, and, in particular, to an auxiliary power source device, a fixing device and an image forming apparatus, each including a plurality of batteries, and a charge operation control method for a plurality of batteries.

2. The Description of the Related Art

For example, a heat-generating member (fixing heater) of a fixing device used in an electrophotographic-type image forming apparatus requires rapid power supply. Japanese Laid-open Patent Applications Nos. 2000-315567, 2002-357966 and 2003-140484 disclose arts for a heat-generating member of a fixing device used for an electrophotographic-type image forming apparatus in which, in addition to power supply from a commercial power source, an auxiliary power source chargeable with the use of an electrical double layer capacitor or such is applied.

Since a capacitor cell of the electrical double layer capacitor or such merely has a small charge capacity, a plurality thereof are connected in series for supplying large power. For a case where large power is required rapidly in such a case where power supply to the above-mentioned fixing device, it is possible to achieve rapid power supply by connecting many capacitor cells in series.

However, in a case where rapid power supply is achieved by means of a series connection of a plurality of capacitor cells, the capacitor cells thus connected in series (referred to as a capacitor unit) cannot be applied to another device of the image forming apparatus than the fixing device as they are, since a required power supply condition may differ for each device. That is, generally speaking, it is necessary to design such a capacitor unit in consideration of the required power supply condition for each device. In fact, the number of the capacitor cells to be connected in series or such depends on each required power supply condition, and thus separate design is required and a design load may increase accordingly.

In order to solve this problem, a design may be made in such a manner that, by providing a plurality of (for example, two of) capacitor units each having a predetermined change capacity, a flexibility is achieved for adapting the capacitor units to each particular power supply condition unique to the image forming apparatus. That is, in the image forming apparatus in the related art, the number of capacitor units is changed so as to adapt to the power supply condition unique to the image forming apparatus.

### SUMMARY FO THE INVENTION

However, there may occur a problem concerning a difference in charge amounts among the respective capacitor units in a case where the plurality of capacitor units are applied as described above. That is, in a case where two capacitor units A and B are provided for example, there may occur a situation in which one capacitor unit A is in a 100% charged state while the other capacitor unit B is in a 50% charged state.

If such a difference occurs in charge amounts between the two capacitor units A and B, charging occurs from the capacitor unit A to the capacitor unit B. In such a case, there may occur a change in the polarity of the capacitor unit B, from the state shown in FIG. 13, (a) to the state shown in FIG. 13, (b), for example. FIG. 13 illustrates a change in the polarity occurring based on a change in the charge amounts between the respective capacitor units. Such a change in the polarity may cause a problem such as a degradation of the capacitor cell or such. Thus, the problem may occur when the capacitor cells are applied as a rechargeable battery.

The present invention has been devised for the purpose of solving the above-mentioned problems, and an object of the present invention is to provide an auxiliary power source device, a fixing device, an image forming apparatus and a charge operation control method in which, in a process of charging a plurality of batteries, it is possible to achieve maximum charge amounts while deviation in the charge amounts is effectively reduced.

According to the present invention, an auxiliary power source device includes: a first battery; a first charger receiving power supply from a commercial power source and charging the first battery; a second battery connected with the first battery in series; a second charger receiving power supply from the commercial power source and charging the second battery; a detecting circuit detecting voltages of the first battery and the second battery; and a control part switching charging operation between the first and second chargers for a final target voltage based on a detection result of the detecting circuit.

The control part may carry out control in such a manner that charging operations of the first and second chargers may be carried out alternately by means of setting a voltage, from beginning of the charging operation for a transition target voltage lower than the final target voltage, and, after the transition target voltage is reached, the control part carries out control such that the charging operations of the first and second chargers may be carried out alternately by means of setting a time.

A fixing device according to the present invention includes: a fixing member configured to press and heat a medium on which a toner image is produced and fix the toner image; a first heat-generating member receiving power from a commercial power source, generating heat and heating the fixing member; and a second heat-generating member receiving power supply from the first and second batteries of the above-mentioned auxiliary power source device, generating heat and heating the fixing member.

An image forming apparatus according to the present invention carries out producing a toner image includes the above-mentioned fixing device for fixing the toner image on a medium.

In a charge operation control method according to the present invention for an auxiliary power source device including first and second batteries, first and second chargers charging the first and second batteries, a detecting circuit detecting voltages of the first and second batteries, and a control part controlling charging operations of the first and second chargers, the control part carries out the steps of: a) causing charging operation to be started from one of the first and second chargers, which one is the charger corresponding to the battery having a lower initial voltage, when a total voltage across both the first and second batteries lowers from a predetermined voltage; and b) carrying out control in such a manner that charging operations of the first and second chargers may be switched therebetween for a final target voltage.

According to the present invention, a charger is provided for each capacitor unit, the capacitor unit having a low initial voltage is selected from among the plurality of capacitor units, and charging is carried out for the thus-selected capacitor unit. When a charge amount of the thus-charged capacitor unit then exceeds a charge amount of the other capacitor unit, an object to which charging is carried out is switched from that capacitor unit to the other capacitor unit. Accordingly, when the plurality of capacitor units are charged, it is possible to reduce a deviation of charge mounts among the respective capacitor units in the charging process, and to achieve uniform charging thereamong.

Further, charging operations of the first and second chargers may be carried out alternately by means of setting a voltage, from beginning of the charging operation for a transition target voltage lower than the final target voltage, and, then, after the transition target voltage is reached, the charging operations of the first and second chargers may be carried out alternately by means of setting a time. Thereby, it is possible to charge for the maximum power reception amount.

According to the present invention it is possible to provide an auxiliary power source device, a fixing device, an image forming apparatus and a charge operation control method in which, in a process of charging a plurality of batteries, it is possible to achieve maximum charge amounts while a deviation in charge amounts is suppressed.

### BRIEF DESCRIPTION OF THE DRAWINGS

Other objects and further features of the present invention will become more apparent from the following detailed description when read in conjunction with the accompanying drawings:

FIG. 1 shows an elevational sectional front view of a digital copier according to a first embodiment of the present invention;

FIG. 2 illustrates a configuration example of a fixing device;

FIG. 3 shows a circuit diagram of a power supply control system mainly for the fixing device of the image forming apparatus;

FIG. 4 shows a circuit diagram of a configuration example of an auxiliary power source device and a periphery thereof;

FIG. 5 shows a circuit diagram of a configuration example of an AC heater driving circuit;

FIG. 6 shows a circuit diagram of a configuration example of a capacitor charger;

FIG. 7 shows a circuit diagram of a configuration example of a capacitor discharge circuit;

FIG. 8 shows a circuit diagram of a configuration example of a control part;

FIG. 9 shows a general flow chart of a control example of charging operation according to an embodiment of the present invention;

FIG. 10 illustrates a switching control example of charging operation of the capacitor charger;

FIG. 11 shows a general flow chart of a control example of charging operation according to a second embodiment of the present invention;

FIG. 12 shows a general flow chart of a control example of charging operation according to a third embodiment of the present invention;

FIG. 13 illustrates a change in a polarity occurring based on a difference in charge amounts between respective capacitor units; and

FIG. 14 illustrates a method for detecting terminal voltages in a terminal voltage detection circuit.

### DETAILED DESCRIPTION OF THE PREFERRED EMBODIMENTS

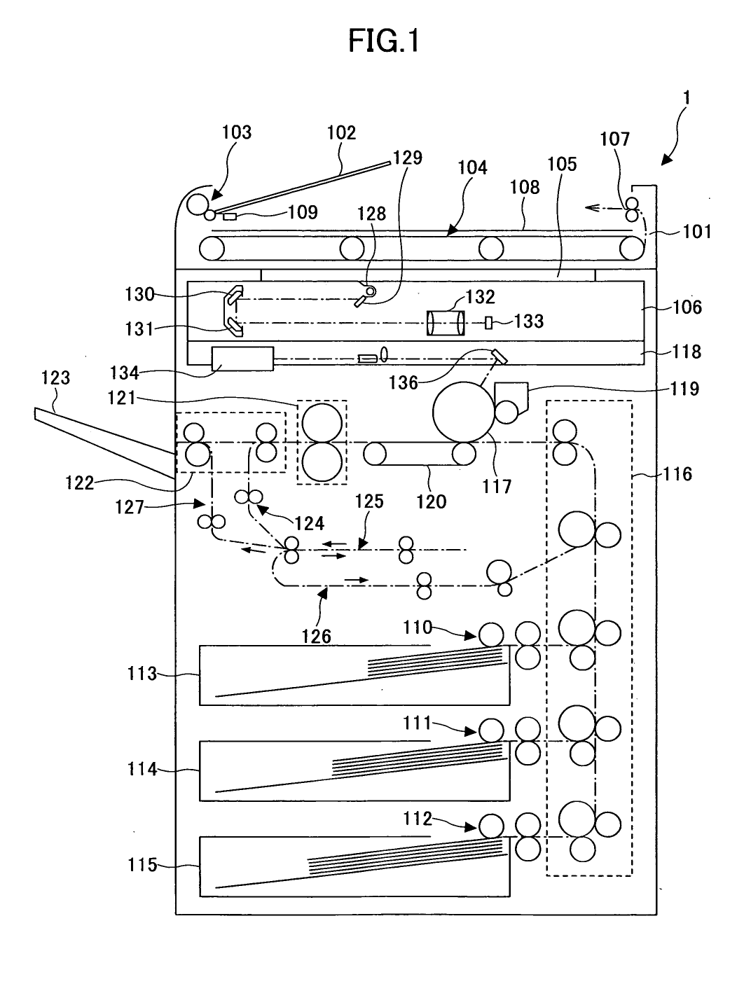

FIG. 1 is an elevational sectional front view showing a general configuration example of a digital copier 1 according to a first embodiment of the present invention. This digital copier 1 acts as an embodiment of an image forming apparatus according to the present invention, and is a so-called composite machine. That is, the digital copier 1 has, in addition of a copy function, a printer function and a facsimile function. By operating an application switching key of an operation part not shown, it is possible to select one from among the copy function, the printer function and the facsimile function in sequence in a switching manner. Thereby, when the copy function is selected, a copy mode is entered; when the printer function is selected, a printer mode is entered; or when the facsimile function is selected, a facsimile mode is entered.

Next, a general configuration of the digital copier 1 and operation thereof in the copy mode are described. In FIG. 1, in a automatic document feeder (referred to as an ADF, hereinafter) 101, an original placed on an original table 102 is fed to a predetermined position on a contact glass 105 by means of paper feeding rollers 103 and a conveying belt 104 when a start key of the operation part not shown is pressed. The ADF 101 has a counting function to count the number of sheets of the original each time when conveyance of a sheet of the original is completed. The original on the contact glass 105 has image information thereof read by an image reading device 106, and then, is ejected to an ejection table 108 by means of the conveyance belt 104 and ejecting rollers 107.

When it is detected that still next sheets of the original exists on the original table 102 by an original set detector 109, the bottom sheet of the original on the original table 102 is then fed to the predetermined position on the contact glass 105 by means of the paper feeding rollers 103 and the conveyance belt 104 in the same manner. The original on the contact glass 105 then has image information thereof read by the image reading device 106, and then, is ejected to the ejection table 108 by means of the conveyance belt 104 and the ejecting rollers 107. The paper feeding rollers 103, the conveyance belt 104 and the ejecting rollers 7 are driven by a conveyance motor.

A first paper feeding device 110, a second paper feeding device 111 or a third paper feeding device 112 feeds a transfer paper stacked therein when it is selected. The transfer paper is then conveyed to a position at which it contacts a photosensitive body 117, by means of a vertical conveyance unit 116. The photosensitive body 117 is, for example, in a form of a photosensitive drum, and is driven and thus rotated by a main motor, not shown.

Image data thus read in by the image reading device 106 from the original undergoes predetermined image processing by means of an image processing device not shown, then is transformed into optical information, and therewith, an electrostatic latent image is produced on the photosensitive drum 117 as a result of the drum being exposed by the optical information from a writing unit 118 after the drum 117 is electrostatically charged uniformly by means of an electrostatic charger not shown. The electrostatic latent image thus-produced on the photosensitive drum 117 is developed by a developing device 119 into a toner image. A printer engine carrying out image forming onto a medium such as a paper sheet according to an electrophotographic method is configured by the above-mentioned writing unit 118, the photosensitive drum 117, the developing device and other necessary well-known devices provided in the periphery of the photosensitive drum 117.

A conveyance belt 120 shown acts as both a paper conveyance device and a transfer device. A transfer bias is applied thereto by a power source, the conveyance belt 120 conveys the transfer paper from the vertical conveyance unit 116 at the same speed as that of the photosensitive drum 117, while the conveyance belt 120 transfers the toner image produced on the photosensitive drum 117 to the transfer paper. This transfer paper then have the toner image, thus transferred thereto, fixed by means of a fixing device 121, and is then ejected by means of a paper ejecting unit 122 to a paper ejecting tray 123. The photosensitive drum 117 has a residual toner, left thereon after the toner image has thus transferred therefrom, cleaned out by a cleaning device not shown.

The above-described operation is one for carrying out copying an image onto one side of the paper sheet in a normal mode. When carrying out producing copied images onto both sides of the paper sheet, paper feeding is carried out by any one of the respective paper feeding trays 113 through 115, and, the transfer paper once having the image produced on one side as described above is not sent to the side of the paper ejecting tray 123 by means of the paper ejecting unit 122, but is switched to be conveyed to the side of a both-side incoming paper conveyance path 124. Then, the transfer paper is switched back and is reversed up side down by means of a reversing unit 125, and is conveyed to a both-side conveyance unit 126.

The transfer paper conveyed to the both-side conveyance unit 126 is conveyed by the both-side conveyed unit 126 to the vertical conveyance unit 116, and then, has a toner image produced on the photosensitive drum 117 in the same way as that described above transferred to the reverse side thereof. The transferred toner image is then fixed by the fixing unit 121, and thus, a both-side copy is produced. This both-side copy is then ejected to the paper ejecting tray 123 by the paper ejecting unit 122.

Further, when the transfer paper once reversed is then to be ejected, the transfer paper once switched back and reversed up side down by the reversing unit 125 is not conveyed to the both-side conveyance unit 126, but is ejected to the paper ejection tray by the paper ejecting unit 122 via a reverse paper ejecting conveyance path 127.

On the other hand, in the printer mode, image data is input to the writing unit 118 from an application software or such, instead of the above-described image data from the image reading device, and an image is formed on transfer paper in the same manner as that described above.

In the facsimile mode, image data from the image reading device is transmitted to a communication counter part by means of a facsimile transmission/reception part. Image data from a communication counter part is received by the facsimile transmission/reception part, and, instead of the above-descried image data from the image reading device, the thus-received image data is input to the writing device, and an image is formed on transfer paper in the same manner as that described above.

Furthermore, the digital copier 1 includes a large-quantity paper feeding device (LCT), a finisher for operation of sorting, punching, stapling or such, and the operation part for setting a mode of reading from an original, setting of a copy magnification rate, setting of a paper feeding shelf, setting of a post processing made by the finisher, for displaying information to an operator or such, each not shown.

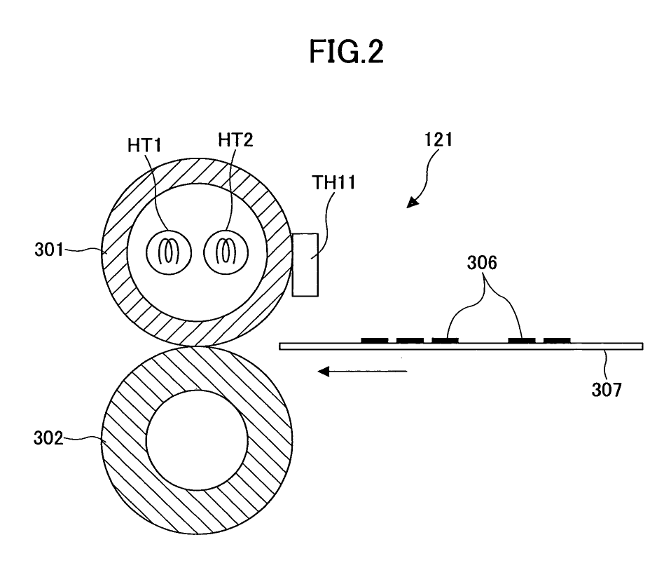

With reference to FIG. 2, a configuration of the fixing device 121 is described. The fixing device 121 acts as a fixing device according to the present invention. In the fixing device 121, as shown, a pressing roller 302 made of an elastic member such as a silicon rubber is pressed to a fixing roller 301 acting as a fixing member with a fixed pressing force applied by means of a pressing member not shown. The fixing member and the pressing member are, in general, have shapes of rollers, respectively. However, either one or both thereof may be made of an endless belt(s). Heaters HT1 and HT2 are provided at arbitrary positions of the fixing device 121. For example, the heaters HT1 and HT2 are located inside of the fixing device 121, and heat the fixing roller 301 from the inside.

The fixing roller 301 and the pressing roller 302 are driven and rotated by means of a driving device not shown. A thermistor TH11 acting as a temperature sensor comes in contact with a surface of the fixing roller 301, and detects a surface temperature (fixing temperature) of the fixing roller 301. A sheet 307 such as a transfer paper, which is a medium carrying a toner image 306 has the toner image fixed by means of heat and pressure applied by the fixing roller 301 and the pressing roller 302 when it passes through a nip part between the fixing roller 301 and the pressing roller 302.

The fixing heater HT2 (first heating member) acts as a main heater to heat the fixing roller 301 and is turned on before the fixing roller 301 reaches a predetermined target temperature Tt which is regarded as a reference value. The fixing heater HT1 (second heating member) is an auxiliary heater for heating the fixing roller 301, and is turned on at a time of turning on of main power of the present digital copier 1, at an occasion of starting up from an energy saving mode (described later), or such. That is, fixing heater HT1 is turned for warming up the fixing device 121.

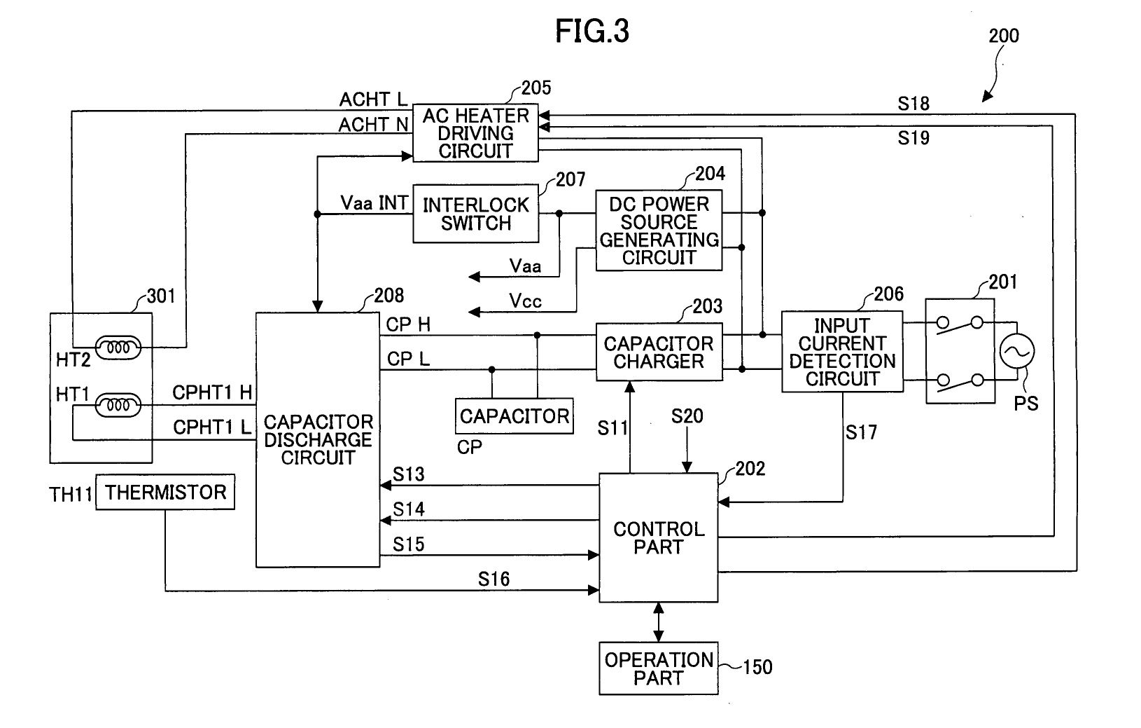

FIG. 3 shows a configuration of a power control system of the digital copier 1 mainly for the fixing device 121. The power control system shown in FIG. 3 includes a main power source SW 201 for turning on/off of supply of an AC power source (commercial power source) PS; a control part 202 provided with a microcomputer for controlling respective parts or such of a power source circuit 200; a capacitor CP acting as a battery which is an auxiliary power source for the fixing heater HT1; a capacitor charger 203 acting as a charger for charging the capacitor CP; a DC power source generating circuit 204 generating a DC power source of the present digital copier 1; an AC heater driving circuit 205 supplying AC power to the AC fixing heater HT2; an input current detection circuit 206 detecting an input current input from the AC power source; an interlock switch 207; and a capacitor discharge circuit 208 supplying DC power to the fixing heater HT1 as a result of discharging from the capacitor CP.

The AC power source PS supplies AC power to the AC heater driving circuit 205, the DC power source generating circuit 204 and the capacitor discharge circuit 203 via the main power source SW 201 and the input current detection circuit 206.

The control part 202 mainly controls the respective parts of the power source circuit 200, and controls operation of the capacitor charger 203, the AC heater driving circuit 205 and the capacitor discharge circuit 208. Specifically, the control part 202 sends a control signal S11 to the capacitor charger 203, and controls operation of the capacitor charger 203 to charge the capacitor CP. Further, the control part 2020 sends control signals S13 and S14 to the capacitor discharge circuit 208, and controls operation of turning on/off of the fixing heater HT1 by means of thus controlling the capacitor discharge circuit 208. The control part also sends control signals S18 and S19 to the AC heater driving circuit 205, and controls operation of turning on/off of the fixing heater HT2 by means of thus controlling the AC heater driving circuit 205.

The input current detection circuit 206 is provided between the main power source SW 201 and the AC heater driving circuit 205, the DC power source generating circuit 204 and the capacitor charger 203, detects the input current of the AC power source input via the main power source SW 201, and outputs a detection current S17 to the control part 202. This input current changes according to operation states of the AC heater driving circuit 205, the DC power source generating circuit 204, the capacitor charger 203 and an image forming apparatus (or the printer engine, i.e., an image forming part of the digital copier 1).

The DC power source generating circuit 204 generates a power source Vcc used mainly for a control system inside of the digital copier 1 based on the AC power input via the main power source SW 201; and a power source Vaa mainly used for a driving system and used for a middle or a high voltage power source.

The interlock switch 207 is turned on/off in cooperation with a cover or such not shown of the digital copier 1. In a case where the digital copier 1 has a driving device, a middle or high voltage power source applied device or such which is touchable if the cover or such of the digital copier 1 is opened, the interlock switch cuts power supply so that operation of the driving device may be stopped, voltage application to the middle or high voltage applied device may be stopped, or such, when the cover is opened. To the interlock switch 207, part of the power source Vaa generated by the DC power source generating circuit 204 is input, which is input from the interlock switch 207 to the capacitor discharge circuit 208 and the AC heater driving circuit 205.

The AC heater driving circuit 205 turns on/off the AC fixing heater HT2 according to the control signals S18 and S19 input from the control part 202.

The capacitor charger 203 is connected to the capacitor CP, and carries out charging of the capacitor CP based on the control signal S11 input from the control part 202.

The capacitor CP is made of a large-capacitance capacitor such as an electric double layer capacitor or such. The capacitor CP is connected to the capacitor charger 203 and the capacitor discharge circuit 208, changing is carried out for the capacitor CP therewith, and power thus charged is in the capacitor CP then supplied to the fixing heater HT1 by means of on/off control of the capacitor discharge circuit 208.

The capacitor discharge circuit 208 causes power charged in the capacitor CP to be discharged according to the input control signals S13 and S14, and the fixing heater HT1 is driven thereby.

The thermistor TH11 is provided in the vicinity of the fixing roller 301, and outputs a detection signal S16 according to the surface temperature of the fixing roller 301, to the control part 202. The thermistor TH11 has its resistance value changing according to the temperature, the control part 202 uses the temperature change of this resistance value and detects the surface temperature of the fixing roller 301.

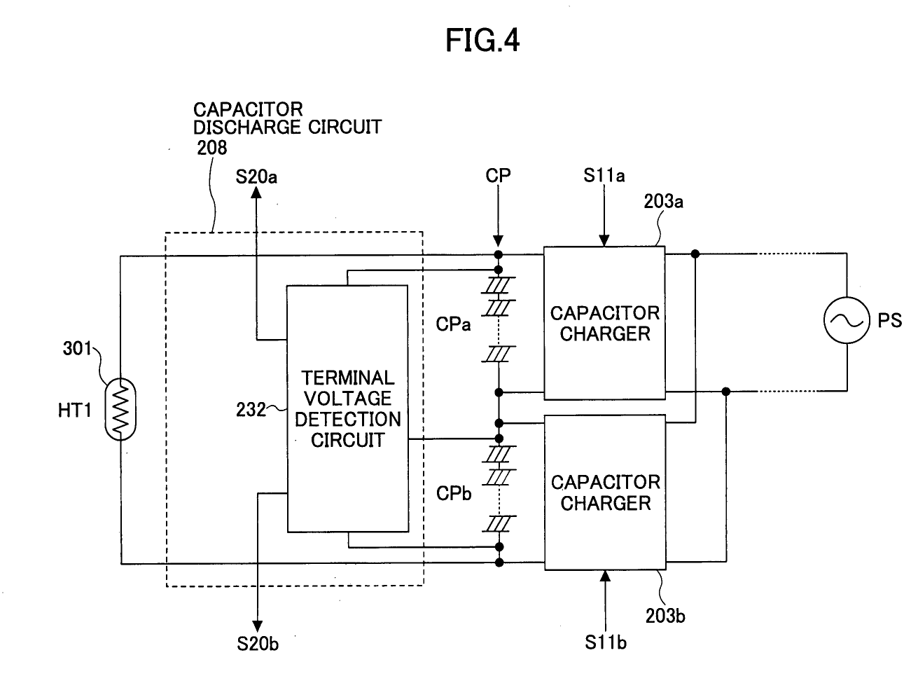

FIG. 4 shows a configuration example of a configuration around the capacitor charger 203 and the capacitor CP which act as an auxiliary power source device in the present embodiment together with the control part 202. According to the present embodiment, the capacitor CP is not made of a single battery, but actually has a configuration in which a capacitor CPa acting as a first battery and a capacitor CPb acting as a second battery are connected in series. Each of these capacitors CPa and CPb itself further has a configuration in which a plurality of capacitor cells are connected in series. Further, these capacitors CPa and CPb may preferably be equal in their charge capacitances (the number of capacitor cells each has).

For these capacitors CPa and CPb, the capacitor charger 203 also includes respective separate capacitor chargers (first and second chargers) 203a and 203b. These capacitor charges 203a and 203b receive AC power from the AC power source PS and charge the capacitors CPa and CPb respectively. The control part 202 sends control signals S11a and S11b to the capacitor chargers 203a and 203b respectively, and thus, charging operations for the respective capacitors CPa and CPb by means of the capacitor chargers 203a and 203b are controllable separately.

A terminal voltage detection circuit 232 is connected for detecting respective terminal voltages of the capacitor CPa and the capacitor CPb as shown in FIG. 4. The terminal voltage detection circuit 232 obtains the terminal voltages of the capacitors CPa and CPb, and outputs them to the control part 202 in a form of voltage signals S20a and S20b, as will be described later.

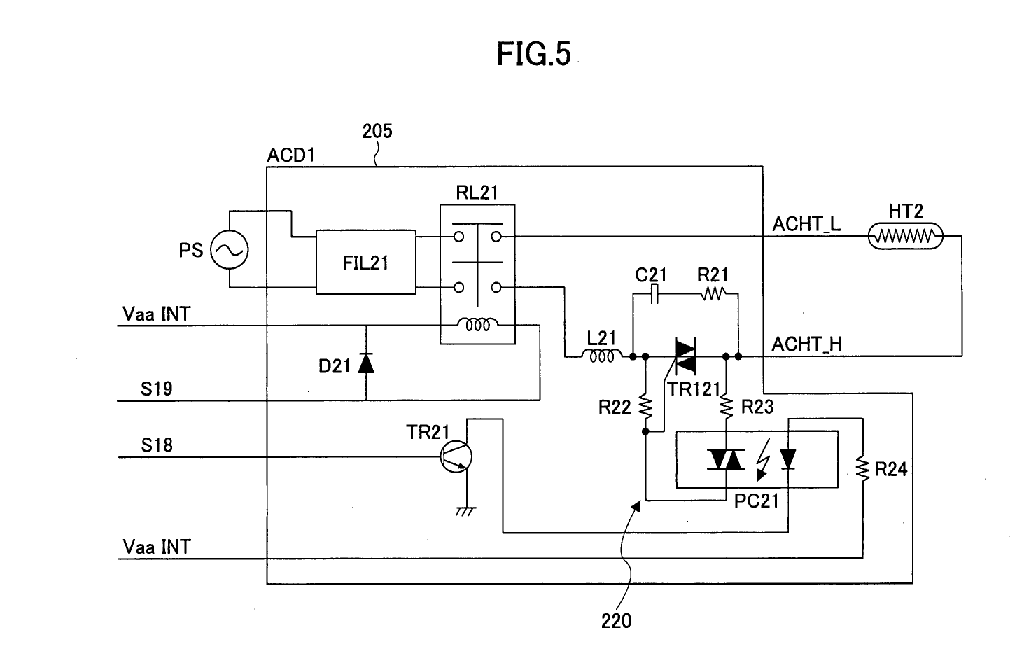

Next, the AC heater driving circuit 205 is described. FIG. 5 shows a configuration of the AC heater driving circuit 205. The AC heater driving circuit 205 includes a filter FIL21 for removing noise of the input AC power source; a fixing relay RL21 provided for safety protection and turned on/off according to a control signal S19 input from the control part 202; a reverse electromotive force preventing diode D21 for the safety protection fixing relay RL21; and a heater on/off circuit 220 for turning on/off the AC fixing heater HT2 based on a control signal S20 input from the control part 202.

The AC power source PS is connected to a primary terminal of the fixing heater HT2 via the filter FIL21 and the safety protection fixing relay RL21. The other terminal of the fixing heater HT2 is connected to the heater on/off circuit 220.

The heater on/off circuit 220 includes a triac TRI121 for turning on/ff power supply from the AC power source; a photo coupler PC21 for turning on a gate of the triac TRI21 and insulating a signal from the control circuit 202 which is on a secondary side; a transistor TR21 for driving a light emitting LED of the photo coupler PC21; a noise absorption snubber circuit including a capacitor C21 and a resistor R21; and resistors R23 and R24 acting as current limiting resistors for the photo coupler PC21.

In the AC heater driving circuit 205 configured as described above, the AC fixing heater HT2 is turned on as a result of power being supplied in a state in which gates of both the safety protection fixing relay RL21 and the transistor TR21 are turned on.

The control part 202 turns on the control signal S19 supplied to the safety protection fixing relay RL21, and, in this state, the control part 202 controls turning on/off of the AC fixing heater HT2 by turning on/off the control signal S18 supplied to the gate of the transistor TR21 of the heater on/off circuit 220.

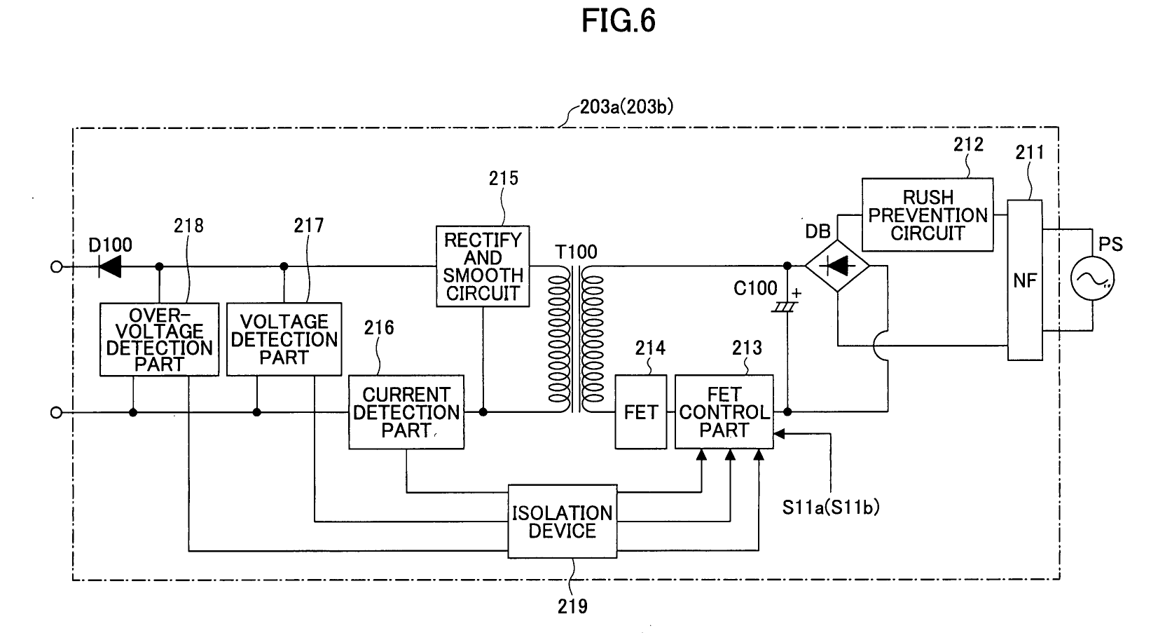

FIG. 6 is a diagram showing a configuration of the capacitor charger 203 shown in FIG. 3. As shown in FIG. 4, the capacitor charger 203 includes the two capacitor chargers 203a and 203b. However, since both of them have the identical configuration, FIG. 6 shows the configuration of each thereof in common. The capacitor charger 203a (203b) includes an NF (noise filter) 211 removing noise from an input AC voltage; a rush current prevention circuit 212 preventing a rush current; a diode bridge DB carrying out full-wave rectification on the AC voltage applied from the AC power source PS via the rush current prevention circuit 212; a capacitor C100 smoothing the AC voltage having undergone the full-wave rectification; an FET control part 213 controlling charging operation for the capacitor CPa (or CPb) (see FIG. 4) by controlling switching of an FET 213; the FET 213 turning on/off a transformer T100; the transformer T100 reducing the input voltage; a rectify and smooth circuit 215 carrying out rectification and smoothing on a secondary output of the transformer T100 and converting it into a DC output; a current detection circuit part 216 detecting a current value of the capacitor CPa (or CPb); a voltage detection part 217 detecting a voltage value of the capacitor CPa (or CPb); an over-voltage detection part 218 detecting an over-voltage of the capacitor CPa (or CPb) for preventing the over-voltage from being applied to the capacitor CPa (or CPb); a diode D100 preventing a backflow from the capacitor CPa (or CPb); and an isolation device 219.

The AC voltage input from the AC power source PS has noise removed by the NF 211, then undergoes full-wave rectification by the diode bridge DB via the rush current preventing circuit 212, and is smoothed by the capacitor C100. The thus-obtained DC voltage is input to a primary side of the transformer T100. The FET control part 213 starts switching control of the FET 214 for charging the capacitor CPa (or CPb) when the control signal S11a (or S11b) input from the control part 202 (see FIGS. 3 and 4) is turned on. The FET control part 213 carries out the switching control of the FET 214 based on the respective detection signals from the current detection part 216, the voltage detection part 217 and the over-voltage detection circuit 218, and carries out constant current control, constant voltage control or constant power control for charging the capacitor CPa (or CPb). Generally speaking, it is preferable to charge the capacitor CPa (or CPb) with a constant current. However, it is possible to shorten a required charging time by charging with a constant voltage.

The transformer T100 is turned on/off by the FET 214, reduces the primary side input voltage, and outputs the reduced voltage from the secondary side. The secondary side output of the transformer T100 undergoes rectification and smoothing by the rectify and smooth circuit 215, and, is output via the diode D100, to the capacitor CPa (or CPb). The secondary side output of the transformer T100 after undergoing rectification and smoothing is detected in its current value, voltage value and over-voltage value by the current detection part 216, the voltage detection part 217 and the over-voltage detection part 218, respectively, and thus-obtained respective detection signals are input to the FET control part 213 via the isolation device 219 as shown.

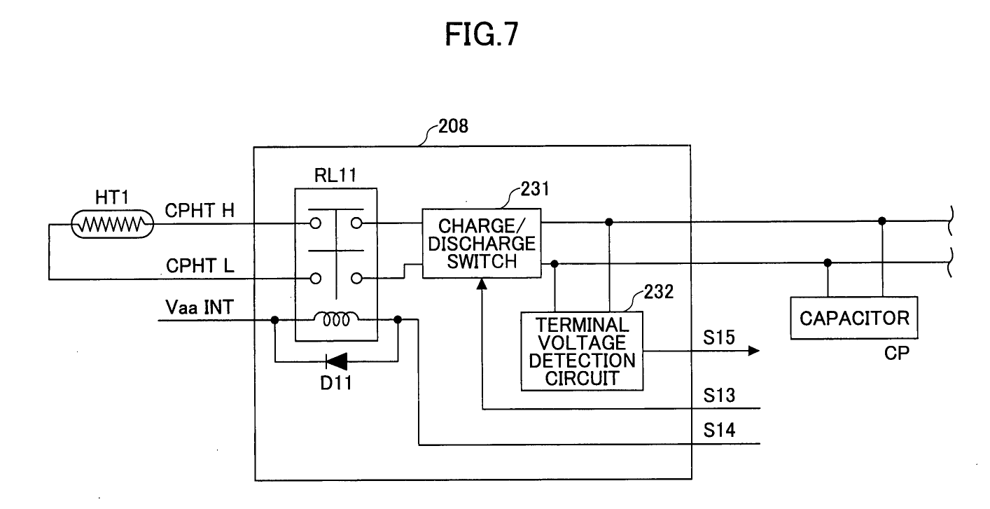

FIG. 7 is a diagram showing a configuration of the capacitor discharge circuit 208 shown in FIG. 3. The capacitor discharge circuit 208 includes, as shown, a charge/discharge switch 231; a safety protection fixing relay RL11; a diode D11 for preventing reverse electromotive force of a fixing relay RL11; and a terminal voltage detection circuit 232 detecting a terminal voltage across the entire capacitor CP, i.e., a voltage across the capacitors CPa and CPb connected in series.

Across the capacitor CP, the charge/discharge switch 231 and the safety protection fixing relay RL11 are connected. The charge/discharge switch 231 is turned on/off by the control signal S13 input from the control part 202. Similarly, the safety protection fixing relay RL11 is turned on/off by the control signal S14 input from the control part 202. When both the charge/discharge switch 231 and the safety protection fixing relay RL11 are turned on, an electric charge is discharged from the capacitor CP and is supplied to the fixing heater HT1.

The terminal voltage detection circuit 232 detects, as shown in FIG. 14, the terminal voltage of the entire capacitor CP Va or the terminal voltage Vb of the capacitor CPb. The terminal voltage of the capacitor CPa can be detected as a result of the terminal voltage Vb being subtracted from the terminal voltage Va of the entire capacitor CP accordingly. The terminal voltage detection circuit 232 detects the terminal voltage of the entire capacitor CP, and outputs a thus-obtained voltage signal S15 to the control part 202. The control part 202 always monitors this voltage signal S15, and thus monitors a charged state of the capacitor CP.

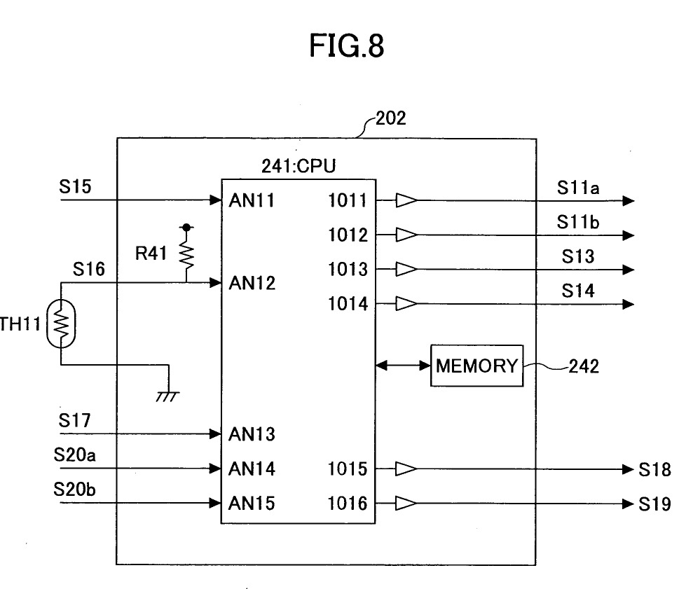

FIG. 8 is a diagram showing a general configuration of the control part 202 shown in FIG. 3. The control part 202 includes, as shown, a CPU 241, a memory 242 and so forth. The CPU 241 is connected with the memory 242 storing therein programs or data used for controlling the digital copier 1, and, based on the programs stored in the memory 242, the CPU 241 carries out control of the printer engine or the power source circuit 200.

To the CPU 241, the voltage signal (analog signal) S15 indicating the terminal voltage of the capacitor CP detected by the terminal voltage detection circuit 232 of the capacitor discharge circuit 208; a detection signal S16 (analog signal) obtained as a result of voltage division by means of respective resistance values of the thermistor TH11 and the resistor R41 for detecting the surface temperature of the fixing roller 301; a detection current signal (analog signal) S17 indicating an input current of the apparatus by means of the input current detection circuit 206; and voltage signals S20a and S20b indicating the particular terminal voltages of the capacitors CPa and CPb obtained from the terminal voltage detection circuit 232 are input.

Further, the CPU 241 outputs the control signals S11a, S11b for turning on/off charging of the capacious CPa, CPb; the control signal S13 for turning on/off the charge/discharge switch 231; the control signal S14 for turning on/off the safety protection fixing relay RL11; the control signal S18 for turning on/off the heater on/off circuit 220; the control signal S19 for turning on/off the safety protection fixing relay RL21, or such (see also FIGS. 3, 4 and 6).

In this configuration, basically, the fixing heater HT2 is turned on, and therewith, the fixing roller 301 is heated, until a predetermined target temperature Tt regarded as a reference value of the fixing roller 301 is reached. On the other hand, at a time of turning on of the main power source of the digital copier 1 or during a starting up time for a copy function available state recovering from the energy saving mode, that is, at a time of warming up of the fixing device 121, the fixing heater HT1 which uses the capacitor CP as the auxiliary power source is also turned on, and together therewith, the fixing roller 301 is heated.

Thus, by applying the capacitor CP made of the electric double layer capacitors as the auxiliary power source, it is possible to avoid degradation in the fixing performance otherwise occurring due to possible power shortage, which may occur when power supply from the AC power source PS to the fixing device is short, since it is possible to supply a large current to the fixing device instantaneously. However, after the discharge is once carried out from the capacitor CP to supply power to the fixing roller 301, it is necessary to again charge the capacitor CP in certain timing.

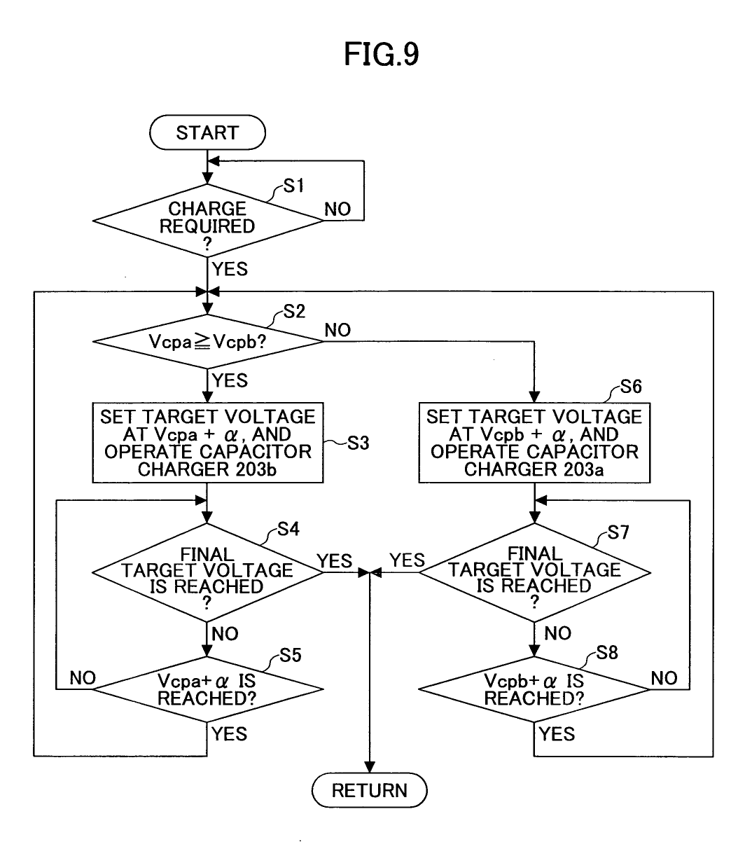

With reference to FIG. 9 showing a general flow chart, an example of control of charging operation for the capacitors CPa and CPb by the capacitor chargers 203a and 203b according to the embodiment of the present invention is described. The charging operation is executed under the control of the CPU 241.

Basically, the charging operation for the capacitor CP is carried out when the terminal voltage of the entire capacitor CP lowers from a predetermined voltage. The voltage signal S15 from the terminal voltage detection circuit 232 is monitored and thereby, it is determined whether or not the charging is needed (Step S1). The predetermined voltage depends on a specification of each particular type of the image forming apparatus, a condition in which the peripheral devices are installed, or such.

When it is determined that the charging is needed, as a result of the terminal voltage of the capacitor CP lowers from the predetermined voltage, with the use of the voltage signal S15 (Yes in Step S1), the voltage signals S20a and S20b (indicating the respective terminal voltages of the capacitors CPa and CPb) at an initial state of the charge beginning, obtained from the terminal voltage detection circuit 232, are compared with each other in their magnitudes (Step S2). The terminal voltage of the capacitor CPa is referred to as Vcpa while the terminal voltage of the capacitor CPb is referred to as Vcpb, hereinafter.

When Vcpa≧Vcpb as a result of the comparison (Yes in Step S2), the control signal S11b for turning on charging operation is output to the capacitor charger 203b corresponding to the capacitor Vcpb having the lower terminal voltage, and charging operation is started for the capacitor CPb from the capacitor charger 203b (Step S3).

As a target voltage of this charging operation, a voltage exceeding the higher terminal voltage Vcpa, that is, a voltage higher than this terminal voltage Vcpa by a prescribed voltage α, i.e., Vcpa+α is applied. At this time, the control signal S-11a for the other capacitor CPa is in a state of turning off charging operation, and thus, no charging operation is carried out for the capacitor CPa by the capacitor charge 203a.

In this charging operation, it is monitored in Step S4 as to whether or not the terminal voltage Vcpb detected by the terminal voltage detection circuit 232 has reached a predetermined final target voltage (for example, 45 V). When it has not been reached (No in Step S4), it is determined in Step S5 whether or not the terminal voltage Vcpb has reached the current target voltage Vcpa+α. When the target voltage Vcpa+α has been reached (Yes in Step S5), the processing is returned to Step S2.

On the other hand, when the state Vcpa≧Vcpb does not occur in the comparison result (No in Step S2), the control signal S11a for turning on charging operation is output to the capacitor charger 203a corresponding to the capacitor Vcpa having the lower terminal voltage in this case, and charging operation is started for the capacitor CPa from the capacitor charger 203a (Step S6).

As a target voltage of this charging operation, a voltage exceeding the higher terminal voltage Vcpb, that is, a voltage higher than this terminal voltage Vcpb by a prescribed voltage α, i.e., Vcpb+α is applied. At this time, the control signal S11b for the capacitor CPb is in a state for turning off charging operation, and thus, no charging operation is carried out for the capacitor CPb by the capacitor charge 203b.

In this charging operation, it is monitored in Step S7 as to whether or not the terminal voltage Vcpa detected by the terminal voltage detection circuit 232 has reached a predetermined final target voltage (for example, 45 V). When it has not been reached (No in Step S7), it is determined in Step S8 whether or not the terminal voltage Vcpa has reached the current target voltage Vcpb+α. When the target voltage Vcpb+α has been reached (Yes in Step S8), the processing is returned to Step S2.

The prescribed voltage α is determined in a value obtained from multiplying a reverse breakdown voltage of one capacitor cell with the total number of the capacitor cells connected in series in each of the capacitors CPa and CPb. For example, when the reverse breakdown voltage of one capacitor cell is 0.2 V and the number of connection in series is 18, 0.2 V×18=3.6 V is determined as the prescribed voltage α.

When the result of Step S5 is Yes, the processing is returned to Step S2 as mentioned above. After that, since the previous state of Vcpa≧Vcpb is thus cancelled, the routine starting from a branch ‘No’ of Step S2 is applied in this case. Similarly, when the result of Step S8 is Yes, the processing is returned to Step S2. After that, since the state of Vcpa≧Vcpb has thus occurred, the routine starting from a branch ‘Yes’ of Step S2 is applied in this case. Then, when one of the voltages, i.e., the Vcpa or Vcpb has reached the final target voltage (Yes in Step S4 or Yes in Step S7), the processing is returned to Step S1.

When the terminal voltage of the entire capacitor CP has not reached the predetermined voltage, further charging is required (Yes in Step S1), and then, one of the routines of the branch ‘No’ and the branch ‘Yes’ of Step S2 is carried out depending on a relationship in the magnitudes between the terminal voltages Vcpa and Vcpb accordingly. When the terminal voltage of the entire capacitor CP has reached the predetermined voltage, the current charging operation is finished.

That is, a trigger to start the above-described alternate charging between the capacitors CPa and CPb is generated from referring to the terminal voltage of the entire capacitor CP shown in FIG. 14. For example, the alternate charging is started when the terminal voltage Va of the entire capacitor CP lowers from the predetermined voltage (for example, 90 V).

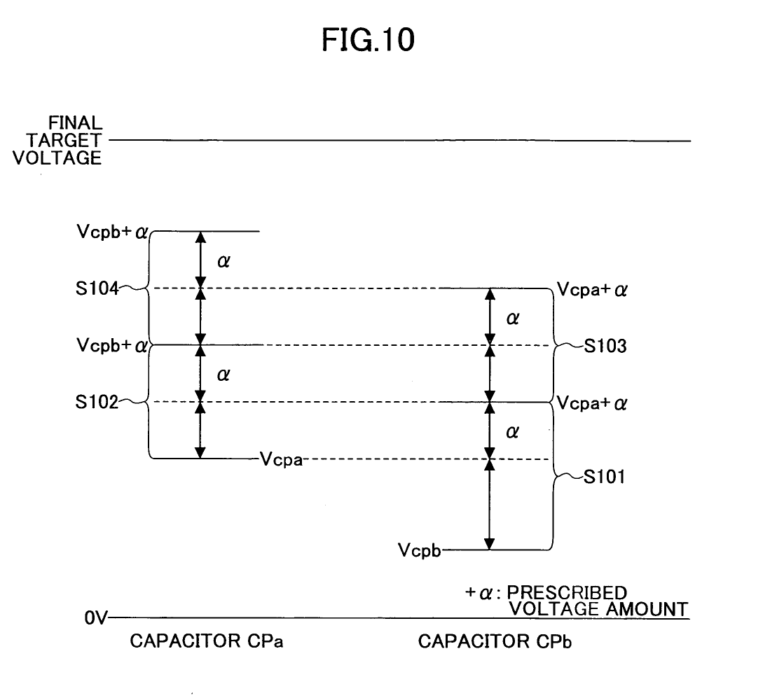

FIG. 10 illustrates an example of switching of such charging operations (alternate charging) of the capacitor chargers 203a and 203b. This example is an example for a case where, when the charging operation is started, the terminal voltage Vcpb of the capacitor CPa is lower. For example, in the case of FIG. 10, the capacitors CPa and CPb are charged alternately in the order of Steps S101 through S104 as shown.

In Step S101, charging of the capacitor CPb from the capacitor charger 203b is started, and the charging is carried out until Vcpa+α, which is higher than the higher terminal voltage Vcpa by the prescribed voltage α, is reached. Next, in Step S102, charging of the capacitor CPa from the capacitor charger 203a is started, and the charging is carried out until Vcpb+α, which is higher than the higher terminal voltage Vcpb at this time by the prescribed voltage α, is reached.

After that, similarly, in Step S103, after charging of the capacitor CPb is carried out until Vcpa+α, which is higher than the higher terminal voltage Vcpa by the prescribed voltage α, is reached, charging of the capacitor CPa from the capacitor charger 203a is started, and this charging is carried out until Vcpb+α, which is higher than the higher terminal voltage Vcpb by the prescribed voltage α, is reached in Step S104.

That is, in the present embodiment, control is carried out to switch charging operations of the capacitor chargers 203a and 203b based on detection result (voltage signals S20a and S20b) of the terminal voltage detection circuit 232 under the control of the CPU 241, for charging the capacitor CP. Especially, in the embodiment, charging operation is started from the capacitor charger 203a or 203b corresponding to the capacitor CPa or CPb having the lower initial terminal voltage, and also, the charging operation is carried out in such a manner that charging of the capacitor CPa and charging of the capacitor CPb may be carried out alternately.

Thus, the required charged voltage (for example, 90 V) of the capacitor CP can be ensured as a total of respective charged voltages of the plurality of capacitor units. Further, each of the capacitor units has its own capacitor charger, and, control is carried out in such a manner that charging operation by each thereof is switched thereamong (alternate charging), for charging the respective capacitor units.

According to the present embodiment, the capacitor unit having the lower initial terminal voltage is selected from among the plurality of capacitor units, and then, charging is carried out therefor. Then, when this capacitor unit thus charged has a charged amount become larger than that of the other capacitor unit, the charging target is switched from the thus-charged capacitor unit to the other capacitor unit. Accordingly, when the plurality of capacitor units are charged, it is possible to achieve charging such that a deviation in the charged amounts among the respective capacitor units may be effectively reduced during the charging.

Especially, in switching control for the alternate charging operation, control is made in such a manner that the originally lower terminal voltage may become higher than the originally higher terminal voltage only by the prescribed voltage α as described above. Therefore, during the charging operation, it is possible to prevent the terminal voltages of both the capacitors CPa and CPb from having a much difference therebetween, and thus, it is possible to achieve balanced charging operation. As the prescribed voltage α, it is preferable to determine a voltage equal to or smaller than the reverse breakdown voltage (normally, on the order of 1.2 V) per capacitor cell, for the plurality of capacitor cells connected in series in each of the capacitors CPa and CPb. By applying the thus-determined prescribed voltage α, it is possible to prevent the reverse breakdown voltage from being applied by one capacitor to the other, and thus, it is possible to achieve very balanced charging operation in which a deviation between the two capacitors CPa and CPb is small.

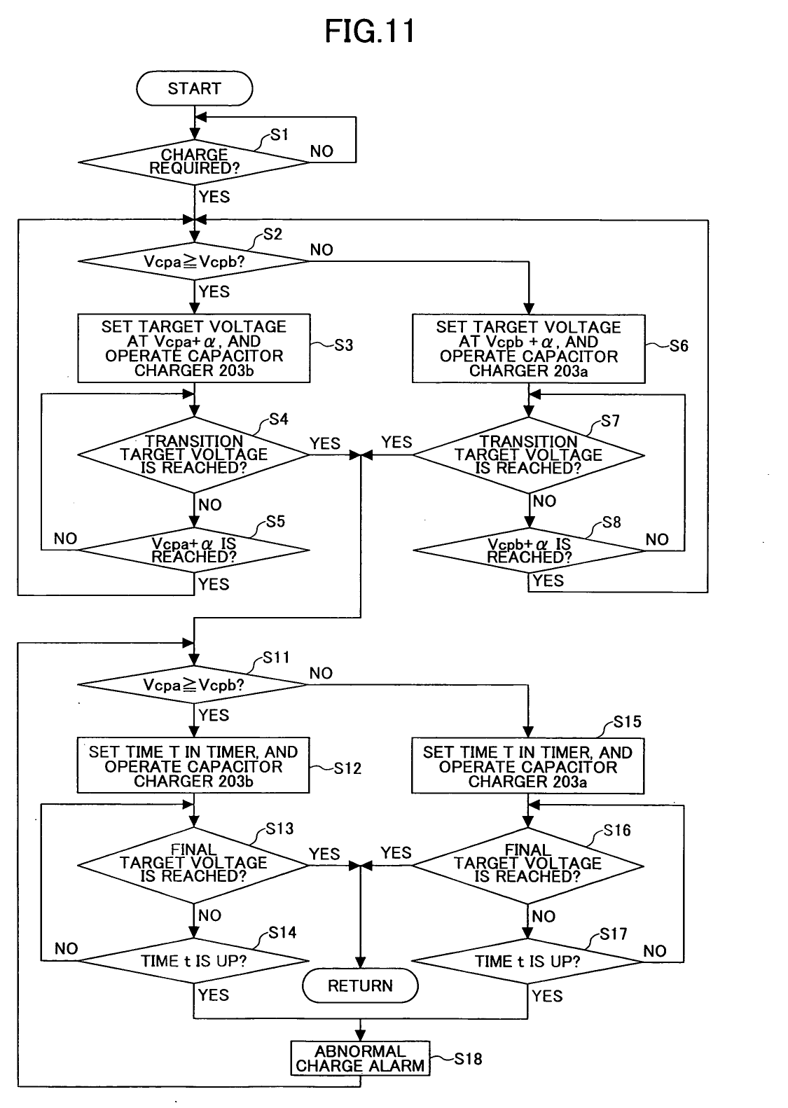

With reference to FIG. 11, a second embodiment of the present invention is described next. The same reference numerals are given to parts same as those of the first embodiment, and description thereof is omitted (the same manner is applied also for a third embodiment described later).

Basically, control of charging operations of the capacitor chargers 203a and 203b are the same as that in the above-described first embodiment. However, unlike the first embodiment, a temporal control is added with the use of a timer for a latter part of the above-described alternate switching control. As the timer, one built in the CPU 241 is applied, for example.

FIG. 11 shows a general flow chart of an example of control of charging operations of the capacitor chargers 203a and 203b in the second embodiment. A transition target voltage (for example, 40 V) lower than the final target voltage (for example, 45 V) is previously set. The charging operation is carried out under the control of the CPU 241.

Basically, the charging operation for the capacitor CP is carried out when the terminal voltage of the entire capacitor CP lowers from a predetermined voltage. The voltage signal S15 from the terminal voltage detection circuit 232 is monitored and thereby, it is determined whether or not the charging is needed (Step S1).

When it is determined that the charging is needed as a result of the terminal voltage of the capacitor CP lowers from the predetermined voltage, with the use of the voltage signal S15 (Yes in Step S1), the voltage signals S20a and S20b at an initial state of the charge beginning obtained from the terminal voltage detection circuit 232 are compared with each other in their magnitudes (Step S2).

When Vcpa≧Vcpb as a result of the comparison (Yes in Step S2), the control signal S11b for turning on charging operation is output to the capacitor charger 203b corresponding to the capacitor Vcpb having the lower terminal voltage, and charging operation is started for the capacitor CPb from the capacitor charger 203b (Step S3). In this charging operation, it is monitored in Step S4 as to whether or not the terminal voltage Vcpb detected by the terminal voltage detection circuit 232 has reached the predetermined transition target voltage (in this example, 40 V). When it has not been reached (No in Step S4), it is determined in Step S5 whether or not the terminal voltage Vcpb has reached the current target voltage Vcpa+α. When the target voltage Vcpa+α has been reached (Yes in Step S5), the processing is returned to Step S2.

On the other hand, when the state Vcpa≧Vcpb does not occur in the comparison result (No in Step S2), the control signal S11a for turning on charging operation is output to the capacitor charger 203a corresponding to the capacitor Vcpa having the lower terminal voltage, and charging operation is started for the capacitor CPa from the capacitor charger 203a (Step S6). In this charging operation, it is monitored in Step S7 as to whether or not the terminal voltage Vcpa detected by the terminal voltage detection circuit 232 has reached the predetermined transition target voltage (in this example, 40 V). When it has not been reached (No in Step S7), it is then determined in Step S8 whether or not the terminal voltage Vcpa has reached the current target voltage Vcpb+α. When the target voltage Vcpb+α has been reached (Yes in Step S8), the processing is returned to Step S2.

When the result of Step S5 is Yes, the processing is returned to Step S2. After that, since the state of Vcpa≧Vcpb is thus cancelled, the routine starting from the branch ‘No’ of Step S2 is applied in this case. Similarly, when the result of Step S8 is Yes, the processing is returned to Step S2. After that, since the state of Vcpa≧Vcpb has thus occurred, the routine starting from the branch ‘Yes’ of Step S2 is applied in this case. Then, when one of the voltages, i.e., the Vcpa or Vcpb has reached the transition target voltage (Yes in Step S4 or Yes in Step S7), processing starting from Step S11 is then carried out.

Then, the voltage signals S20a (Vcpa) and S20b (Vcpb) obtained from the terminal voltage detection circuit 232 are compared with each other in their magnitudes (Step S11).

When Vcpa≧Vcpb as a result of the comparison (Yes in Step S11) for example, the control signal S11b for turning on charging operation is output to the capacitor charger 203b corresponding to the capacitor Vcpb having the lower terminal voltage, and charging operation is started for the capacitor CPb from the capacitor charger 203b (Step S12). At this time, a predetermined time period t is set on the timer for carrying out this charging operation. As the predetermined time period t, it is preferable to apply a time period such that, by the charging operation carried out for the predetermined time period, a voltage exceeding the higher terminal voltage Vcpa may be reached. It is noted that, at this time, the control signal S11a for the capacitor CPa is in a state of turning off charging operation, and thus, no charging operation is carried out for the capacitor CPa by the capacitor charge 203a.

In this charging operation, it is monitored in Step S13 as to whether or not the terminal voltage Vcpb detected by the terminal voltage detection circuit 232 has reached the predetermined final target voltage (in this example, 45 V). When it has not been reached (No in Step S13), it is determined in Step S14 with the use of the timer whether or not the above-mentioned predetermined time period t has elapsed. When the predetermined time period t has elapsed (Yes in Step S14), Step S18 is then carried out. In Step S18, an alarm is generated to indicate an abnormal charging state, and then, the processing is returned to Step S11. When the predetermined time period t has not elapsed (No in Step S14), the processing is returned to Step S13.

On the other hand, when Vcpa≧Vcpb does not occur as a result of the comparison (No in Step S11) for example, the control signal S11a for turning on charging operation is output to the capacitor charger 203a corresponding to the capacitor Vcpa having the lower terminal voltage, and charging operation is started for the capacitor CPa from the capacitor charger 203a (Step S15). At this time, a predetermined time period t is set on the timer for carrying out this charging operation. As the predetermined time period t, it is preferable to apply a time period such that, by the charging operation carried out for the predetermined time period t, a voltage exceeding the higher terminal voltage Vcpb may be reached. At this time, the control signal S11b for the capacitor CPb is in a state of turning off charging operation, and thus, no charging operation is carried out for the capacitor CPb by the capacitor charge 203b.

In this charging operation, it is monitored in Step S16 as to whether or not the terminal voltage Vcpa detected by the terminal voltage detection circuit 232 has reached the predetermined final target voltage (in this example, 45 V). When it has not been reached (No in Step S16), it is determined in Step S17 whether or not the above-mentioned predetermined time period t has elapsed. When the predetermined time period t has elapsed (Yes in Step S17), Step S18 is then carried out. In Step S18, an alarm is generated to indicate an abnormal charging state, and then, the processing is returned to Step S11. When the predetermined time period t has not elapsed (No in Step S17), the processing is returned to Step S16.

Then, when one of the terminal voltage Vcpa or Vcpb has reached the final target voltage (45 V) (Yes in Step S13 or Yes in Step S16), the processing is returned to Step S1. According to common characteristics of such a configuration, the following phenomenon may occur. That is, in a case where the target charged voltage is one in a full-charged state (a state in which charging has been carried out for a maximum charged amount) of the capacitor CPa or CPb, and is 45 V, the charged amount slightly lowers to the order of 40 V, for example, when the current supply is stropped after 45 V has been reached through the charging operation with a constant current for example. The second embodiment is devised for solving this problem.

That is, according to the second embodiment, charging is carried out for the transition target voltage lower than the final target voltage, in the same manner as that in the first embodiment. After the transition target voltage has been reached, charging operations by the capacitor chargers 203a and 203b are carried out alternately under the control of the timer according to the predetermined time period t set in the timer. Accordingly, when the plurality of capacitor units are charged, it is possible to achieve a full charged state while a deviation in the charged amounts between the respective capacitor units are reduced in the charging process.

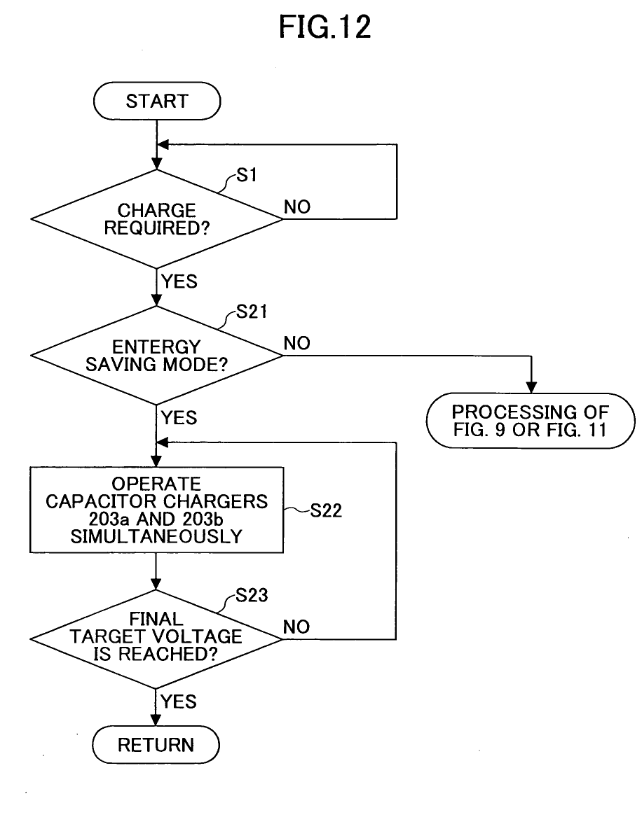

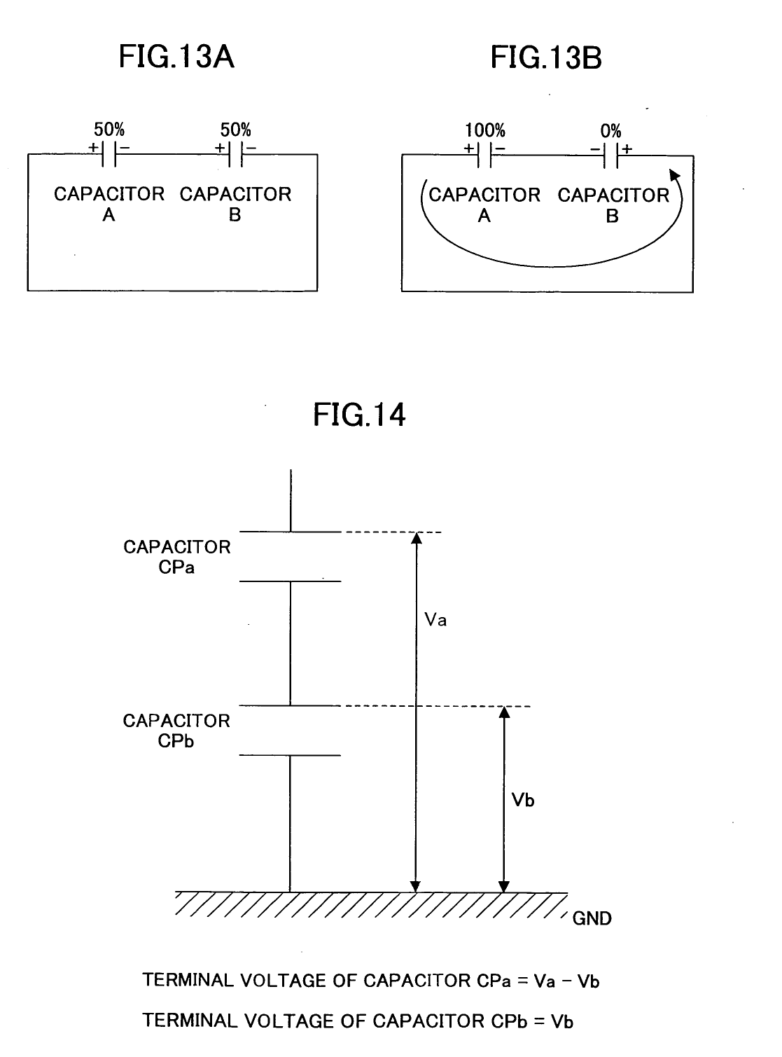

A third embodiment of the present invention is described next with reference to FIG. 12. The third embodiment is an embodiment in which the present invention is applied for a case where the digital copier 1 has a so-called energy saving mode.

The digital copier according to the third embodiment of the present invention has a function for the energy saving mode. That is, in the digital copier 1, when a predetermined requirement is met, that is, when a predetermined time has elapsed while a standby state continues in which the digital copier 1 is not actually used, or such, power is supplied only to a part of a power load, while a power supply is stopped for the remaining almost all the other power loads. Thus, power saving or energy saving is achieved. In this case, when further a predetermined condition (referred to as a recovery condition) is met after the power supply to the almost all the power loads has been stopped, that is, when a user touches an operation key of the operation part (not shown) for example, the power supply to the respective devices is started again (power control part). As such a function is well-known, details of a configuration achieving the basic function for the energy saving mode is omitted. As the above-mentioned recovery condition for recovering from the energy saving mode, other than the above-mentioned example of touching to the operation key by the user, a detection of a state that an original is placed on the original table 102, a detection of a state that facsimile reception occurs when the digital copier 1 has the facsimile function, a detection of reception of a printer job, or such, may be applied instead.

The third embodiment is an embodiment for a control of charging operation of the capacitor chargers 203 (203a, 203b) for the case of the digital copier 1 has the above-mentioned energy saving mode as mentioned above. A general flow chart thereof is shown in FIG. 12.

Charging operation for the capacitor CP is carried out when the terminal voltage of the entire capacitor CP lowers from the predetermined voltage the same as in the above-described embodiments. Whether or not the charging is needed is determined in Step S1 as a result of the voltage signal S15 from the terminal voltage detection circuit 232 being monitored. When it is determined from the voltage signal S15 that the terminal voltage of the capacitor CP lowers and thus the charging is needed (Yes in Step S1), it is determined whether or not the digital copier 1 is in the energy saving mode (Step S21). When the digital copier 1 is not in the energy saving mode (No in Step S21), alternate switching control the same as that described above (for example, the control starting from Step S2 in FIG. 9 or 11) is carried out.

On the other hand, when the digital copier 1 is in the energy saving mode (Yes in Step S21), unlike the above-described control, the control signals S11a and S11b are simultaneously output to simultaneously turn on the charging operations of the two capacitor chargers 203a and 203b, and thus, charging of both the capacitors CPa and CPb is started (Step S22). In this charging operation, it is monitored as to whether or not each of the terminal voltages Vcpa and Vcpb detected by the terminal voltage detection circuit 232 has reached a predetermined final target voltage (for example, 45 V) (Step S23). When it has not been reached (No in Step S23), the charging operation is continued (Step S22) until it is reached (Yes in Step S23). After that, the processing is returned to Step S1.

That is, according to the third embodiment, the capacitor charges 203a and 203b are caused to carry out the charging operations simultaneously when the charging operation is carried out in the energy saving mode, under the control of the CPU 241. On the other hand, when the charging operation is carried out, not in the energy saving mode, the switching control is carried out such that the charging operations of the capacitor chargers 203a and 203b are carried out alternately.

The energy saving mode is applied for the purpose of achieving power saving in the standby state in which, a state in which the digital copier 1 is not actually used continues. In the energy saving mode, since no image forming operation is carried out there, there occurs no problem even when all the power of the AC power source PS is consumed for charging the capacitor CP (capacitors CPa and CPb). By carrying out the charging operations of the capacitor chargers 203a and 203b simultaneously in the energy saving mode, it is possible to shorten a required time to finish the charging operations for the capacitors CPa and CPb. Thereby, it is possible to recover to the energy saving mode of the normal condition accordingly, and thus, it is possible to effectively reduce the influence of the charging operations applied to the energy saving mode itself.

In the third embodiment, the capacitor chargers 203a and 203b are caused to carry out the charging operations simultaneously in the energy saving mode as mentioned above. However, it is not necessary to limit an occasion of carrying out such simultaneously charging operation to the energy saving mode. Such operation of carrying out the charging operations by both the chargers simultaneously may also be applied for another case in which a power supply to the digital copier 1 becomes surplus. For example, in a mode in which image forming operation is not carried out, that is, in a mode in which the digital copier 1 merely acts as a printer server, in a mode in which only scanner operation or facsimile transmission operation is carried out, a power surplus may occur which allows carrying out the charging operations of the capacitor chargers 203a and 203b simultaneously.

As a variant embodiment of the third embodiment, the simultaneous charging is allowed instead of the alternate charging, by carrying out constant power charging with a charging power of 100 W which is one reduced from a normal charging power of 200 W with which the charging is carried out normally.

Further, the present invention is not limited to the above-described embodiments, and variations and modifications may be made without departing from the basic concept of the present invention claimed below.

The present application is based on Japanese Priority Applications Nos. 2004-021043 and 2004-352946, filed on Jan. 29, 2004 and Dec. 6, 2004, respectively, the entire contents of which are hereby incorporated herein by reference.

1. An auxiliary power source device comprising:
a first battery;
a first charger receiving power supply from a commercial power source and charging the first battery;
a second battery connected with the first battery in series;
a second charger receiving power supply from the commercial power source and charging the second battery;
a detecting circuit detecting voltages of the first battery and the second battery; and
a control part switching charging operation between the first and second chargers for a final target voltage based on a detection result of the detecting circuit.

2. The auxiliary power source device as claimed in claim 1, wherein:
said control part carries out control for the final target voltage in such a manner that charging operations of the first and second chargers may be carried out alternately.

3. The auxiliary power source device as claimed in claim 2, wherein:
said control part causes charging operation to be started from one of the first and second chargers, which one is the charger corresponding to the battery having a lower initial voltage detected at a time of beginning of the charging operation.

4. The auxiliary power source device as claimed in claim 2, wherein:
the control part carries out control in such a manner that the charging operations of the first and second chargers may be carried out alternately in such a manner that the voltages of the batteries may exceed one another alternately.

5. The auxiliary power source device as claimed in claim 4, wherein:
said manner of the voltages of the batteries exceeding one another alternately is such that the voltage of one battery previously having a lower voltage may then exceed the voltage of the other battery only by a predetermined voltage.

6. The auxiliary power source device as claimed in claim 5, wherein:
each of said first and second batteries comprises a plurality of capacitors connected in series; and
said predetermined voltage is a voltage obtained from multiplying a reverse breakdown voltage per cell of the capacitor by the number of the plurality of capacitors connected in series.

7. The auxiliary power source device as claimed in claim 1, wherein:
said control part carries out control in such a manner that charging operations of the first and second chargers may be carried out alternately by means of setting a voltage, from beginning of the charging operation for a transition target voltage lower than the final target voltage, and, after the transition target voltage is reached, the control part then carries out control such that the charging operations of the first and second chargers may be carried out alternately by means of setting a time.

8. The auxiliary power source device as claimed in claim 1, wherein:
said control part causes charging operation to be started from the first charger or from the second charger when the total voltage across both the first and second batteries lowers from a predetermined voltage.

9. The auxiliary power source device as claimed in claim 1, wherein:
said detecting circuit detects the total voltage across both the first and second batteries and the voltage of the second batteries, and detects the voltage of the first battery by subtracting the detected voltage of the second battery from the detected total voltage across both the first and second bastes.

10. A fixing device comprising:
a fixing member configured to press and heat a medium on which a toner image is produced and fix the toner image;
a first heat-generating member receiving power from a commercial power source, generating heat and heating the fixing member; and
a second heat-generating member receiving power supply from the first and second batteries of the auxiliary power source device claimed in claim 1, generating heat and heating the fixing member.

11. A fixing device comprising:
a fixing member configured to press and heat a medium on which a toner image is produced and fix the toner image;
a first heat-generating member receiving power from a commercial power source, generating heat and heating the fixing member; and
a second heat-generating member receiving power supply from the first and second batteries of the auxiliary power source device claimed in claim 2, generating heat and heating the fixing member.

12. A fixing device comprising:
a fixing member configured to press and heat a medium on which a toner image is produced and fix the toner image;
a first heat-generating member receiving power from a commercial power source, generating heat and heating the fixing member; and
a second heat-generating member receiving power supply from the first and second batteries of the auxiliary power source device claimed in claim 3, generating heat and heating the fixing member.

13. A fixing device comprising:
a fixing member configured to press and heat a medium on which a toner image is produced and fix the toner image;
a first heat-generating member receiving power from a commercial power source, generating heat and heating the fixing member; and
a second heat-generating member receiving power supply from the first and second batteries of the auxiliary power source device claimed in claim 4, generating heat and heating the fixing member.

14. A fixing device comprising:
a fixing member configured to press and heat a medium on which a toner image is produced and fix the toner image;
a first heat-generating member receiving power from a commercial power source, generating heat and heating the fixing member; and
a second heat-generating member receiving power supply from the first and second batteries of the auxiliary power source device claimed in claim 5, generating heat and heating the fixing member.

15. A fixing device comprising:
a fixing member configured to press and heat a medium on which a toner image is produced and fix the toner image;
a first heat-generating member receiving power from a commercial power source, generating heat and heating the fixing member; and
a second heat-generating member receiving power supply from the first and second batteries of the auxiliary power source device claimed in claim 6, generating heat and heating the fixing member.

16. A fixing device comprising:
a fixing member configured to press and heat a medium on which a toner image is produced and fix the toner image;
a first heat-generating member receiving power from a commercial power source, generating heat and heating the fixing member; and
a second heat-generating member receiving power supply from the first and second batteries of the auxiliary power source device claimed in claim 7, generating heat and heating the fixing member.

17. A fixing device comprising:
a fixing member configured to press and heat a medium on which a toner image is produced and fix the toner image;
a first heat-generating member receiving power from a commercial power source, generating heat and heating the fixing member; and
a second heat-generating member receiving power supply from the first and second batteries of the auxiliary power source device claimed in claim 8, generating heat and heating the fixing member.

18. A fixing device comprising:
a fixing member configured to press and heat a medium on which a toner image is produced and fix the toner image;
a first heat-generating member receiving power from a commercial power source, generating heat and heating the fixing member; and
a second heat-generating member receiving power supply from the first and second batteries of the auxiliary power source device claimed in claim 9, generating heat and heating the fixing member.

19. An image forming apparatus carrying out producing a toner image, and comprising the fixing device claimed in claim 10 for fixing the toner image on a medium.

20. An image forming apparatus carrying out producing a toner image, and comprising the fixing device claimed in claim 11 for fixing the toner image on a medium.

21. An image forming apparatus carrying out producing a toner image, and comprising the fixing device claimed in claim 12 for fixing the toner image on a medium.

22. An image forming apparatus carrying out producing a toner image, and comprising the fixing device claimed in claim 13 for fixing the toner image on a medium.

23. An image forming apparatus carrying out producing a toner image, and comprising the fixing device claimed in claim 14 for fixing the toner image on a medium.

24. An image forming apparatus carrying out producing a toner image, and comprising the fixing device claimed in claim 15 for fixing the toner image on a medium.

25. An image forming apparatus carrying out producing a toner image, and comprising the fixing device claimed in claim 16 for fixing the toner image on a medium.

26. An image forming apparatus carrying out producing a toner image, and comprising the fixing device claimed in claim 17 for fixing the toner image on a medium.

27. An image forming apparatus carrying out producing a toner image, and comprising the fixing device claimed in claim 18 for fixing the toner image on a medium.

28. The image forming apparatus as claimed in claim 19, further comprising:
a power control part carrying out control such that, when a predetermined condition is met, an energy saving mode may be entered in which power supply to a part of a power load is stopped, while, when a predetermined condition is met under the condition where power supply to the part of the power load is thus stopped, the partial stop of the power supply may be cancelled, wherein:
said power control part carries out control such that, when the charging operation is carried out in the energy saving mode, the first and second chargers may carry out charging operations simultaneously, while carrying out control such that, when the charging operation is carried out, not in the energy saving mode, changing operations of the first and second charger may be carried out alternately.

29. The image forming apparatus as claimed in claim 20, further comprising:
a power control part carrying out control such that, when a predetermined condition is met, an energy saving mode may be entered in which power supply to a part of a power load is stopped, while, when a predetermined condition is met under the condition where power supply to the part of the power load is stopped, the partial stop of the power supply may be cancelled, wherein:
said power control part carry out control such that, when the charging operation is carried out in the energy saving mode, the first and second chargers may carry out charging operations simultaneously, while carrying out control such that, when the charging operation is carried out, not in the energy saving mode, changing operations of the first and second charger may be carried out alternately.

30. The image forming apparatus as claimed in claim 21, further comprising:
a power control part carrying out control such that, when a predetermined condition is met, an energy saving mode may be entered in which power supply to a part of a power load is stopped, while, when a predetermined condition is met under the condition where power supply to the part of the power load is stopped, the partial stop of the power supply may be cancelled, wherein:
said power control part carry out control such that, when the charging operation is carried out in the energy saving mode, the first and second chargers may carry out charging operations simultaneously, while carrying out control such that, when the charging operation is carried out, not in the energy saving mode, changing operations of the first and second charger may be carried out alternately.

31. The image forming apparatus as claimed in claim 22, further comprising:
a power control part carrying out control such that, when a predetermined condition is met, an energy saving mode may be entered in which power supply to a part of a power load is stopped, while, when a predetermined condition is met under the condition where power supply to the part of the power load is stopped, the partial stop of the power supply may be cancelled, wherein:
said power control part carry out control such that, when the charging operation is carried out in the energy saving mode, the first and second chargers may carry out charging operations simultaneously, while carrying out control such that, when the charging operation is carried out, not in the energy saving mode, changing operations of the first and second charger may be carried out alternately.

32. The image forming apparatus as claimed in claim 23, further comprising:
a power control part carrying out control such that, when a predetermined condition is met, an energy saving mode may be entered in which power supply to a part of a power load is stopped, while, when a predetermined condition is met under the condition where power supply to the part of the power load is stopped, the partial stop of the power supply may be cancelled, wherein:
said power control part carry out control such that, when the charging operation is carried out in the energy saving mode, the first and second chargers may carry out charging operations simultaneously, while carrying out control such that, when the charging operation is carried out, not in the energy saving mode, changing operations of the first and second charger may be carried out alternately.

33. The image forming apparatus as claimed in claim 24, further comprising:
a power control part carrying out control such that, when a predetermined condition is met, an energy saving mode may be entered in which power supply to a part of a power load is stopped, while, when a predetermined condition is met under the condition where power supply to the part of the power load is stopped, the partial stop of the power supply may be cancelled, wherein:
said power control part carry out control such that, when the charging operation is carried out in the energy saving mode, the first and second chargers may carry out charging operations simultaneously, while carrying out control such that, when the charging operation is carried out, not in the energy saving mode, changing operations of the first and second charger may be carried out alternately.

34. The image forming apparatus as claimed in claim 25, further comprising:
a power control part carrying out control such that, when a predetermined condition is met, an energy saving mode may be entered in which power supply to a part of a power load is stopped, while, when a predetermined condition is met under the condition where power supply to the part of the power load is stopped, the partial stop of the power supply may be cancelled, wherein:
said power control part carry out control such that, when the charging operation is carried out in the energy saving mode, the first and second chargers may carry out charging operations simultaneously, while carrying out control such that, when the charging operation is carried out, not in the energy saving mode, changing operations of the first and second charger may be carried out alternately.

35. The image forming apparatus as claimed in claim 26, further comprising:
a power control part carrying out control such that, when a predetermined condition is met, an energy saving mode may be entered in which power supply to a part of a power load is stopped, while, when a predetermined condition is met under the condition where power supply to the part of the power load is stopped, the partial stop of the power supply may be cancelled, wherein:
said power control part carry out control such that, when the charging operation is carried out in the energy saving mode, the first and second chargers may carry out charging operations simultaneously, while carrying out control such that, when the charging operation is carried out, not in the energy saving mode, changing operations of the first and second charger may be carried out alternately.

36. The image forming apparatus as claimed in claim 27, further comprising:
a power control part carrying out control such that, when a predetermined condition is met, an energy saving mode may be entered in which power supply to a part of a power load is stopped, while, when a predetermined condition is met under the condition where power supply to the part of the power load is stopped, the partial stop of the power supply may be cancelled, wherein:
said power control part carry out control such that, when the charging operation is carried out in the energy saving mode, the first and second chargers may carry out charging operations simultaneously, while carrying out control such that, when the charging operation is carried out, not in the energy saving mode, changing operations of the first and second charger may be carried out alternately.

37. The image forming apparatus as claimed in claim 28, wherein:
when a power consumption is smaller than a predetermined amount, the power control part carries out control such that, when the charging operation is carried out, not in the energy saving mode, the first and second chargers may carry out charging operations simultaneously.

38. The image forming apparatus as claimed in claim 29, wherein:
when a power consumption is smaller than a predetermined amount, the power control part carries out control such that, when the charging operation is carried out, not in the energy saving mode, the first and second chargers may carry out charging operations simultaneously.

39. The image forming apparatus as claimed in claim 30, wherein:
when a power consumption is smaller than a predetermined amount, the power control part carries out control such that, when the charging operation is carried out, not in the energy saving mode, the first and second chargers may carry out charging operations simultaneously.

40. The image forming apparatus as claimed in claim 31, wherein:
when a power consumption is smaller than a predetermined amount, the power control part carries out control such that, when the charging operation is carried out, not in the energy saving mode, the first and second chargers may carry out charging operations simultaneously.

41. The image forming apparatus as claimed in claim 32, wherein:
when a power consumption is smaller than a predetermined amount, the power control part carries out control such that, when the charging operation is carried out, not in the energy saving mode, the first and second chargers may carry out charging operations simultaneously.

42. The image forming apparatus as claimed in claim 33, wherein:
when a power consumption is smaller than a predetermined amount, the power control part carries out control such that, when the charging operation is carried out, not in the energy saving mode, the first and second chargers may carry out charging operations simultaneously.

43. The image forming apparatus as claimed in claim 34, wherein:
when a power consumption is smaller than a predetermined amount, the power control part carries out control such that, when the charging operation is carried out, not in the energy saving mode, the first and second chargers may carry out charging operations simultaneously.

44. The image forming apparatus as claimed in claim 35, wherein:
when a power consumption is smaller than a predetermined amount, the power control part carries out control such that, when the charging operation is carried out, not in the energy saving mode, the first and second chargers may carry out charging operations simultaneously.

45. The image forming apparatus as claimed in claim 36, wherein:
when a power consumption is smaller than a predetermined amount, the power control part carries out control such that, when the charging operation is carried out, not in the energy saving mode, the first and second chargers may carry out charging operations simultaneously.

46. The image forming apparatus as claimed in claim 37, wherein:
said power control part determines that the power consumption is smaller than the predetermined amount when image forming operation is not carried out.

47. The image forming apparatus as claimed in claim 38, wherein:
said power control part determines that the power consumption is smaller than the predetermined amount when image forming operation is not carried out.

48. The image forming apparatus as claimed in claim 39, wherein:
said power control part determines that the power consumption is smaller than the predetermined amount when image forming operation is not carried out.

49. The image forming apparatus as claimed in claim 40, wherein:
said power control part determines that the power consumption is smaller than the predetermined amount when image forming operation is not carried out.

50. The image forming apparatus as claimed in claim 41, wherein:
said power control part determines that the power consumption is smaller than the predetermined amount when image forming operation is not carried out.

51. The image forming apparatus as claimed in claim 42, wherein:
said power control part determines that the power consumption is smaller than the predetermined amount when image forming operation is not carried out.

52. The image forming apparatus as claimed in claim 43, wherein:
said power control part determines that the power consumption is smaller than the predetermined amount when image forming operation is not carried out.

53. The image forming apparatus as claimed in claim 44, wherein:
said power control part determines that the power consumption is smaller than the predetermined amount when image forming operation is not carried out.

54. The image forming apparatus as claimed in claim 45, wherein:
said power control part determines that the power consumption is smaller than the predetermined amount when image forming operation is not carried out.

55. A charge operation control method for an auxiliary power source device comprising first and second batteries, first and second chargers charging the first and second batteries, a detecting circuit detecting voltages of the first and second batteries, and a control part controlling charging operations of the first and second chargers, wherein:
said control part carries out the steps of:
a) causing charging operation to be started from one of the first and second chargers, which one is the charger corresponding to the battery having a lower initial voltage, when a total voltage across both the first and second batteries lowers from a predetermined voltage; and
b) carrying out control in such a manner that charging operations of the first and second chargers may be switched therebetween for a final target voltage.

56. The charge operation control method as claimed in claim 55, wherein:
said step b) comprises the step of carrying out the switching control in such a manner that the changing operations of the first and second charges may be carried out alternately.

57. The charge operation control method as claimed in claim 55, wherein:
said step b) comprises the step of carrying out the switching control in such a manner that the changing operations of the first and second charges may be carried out alternately in such a manner that the detected voltages of the batteries may exceed one another alternately

58. The charge operation control method as claimed in claim 55, wherein:
said step b) comprises the step of carrying out the switching control in such a manner that the charging operations of the first and second chargers may be carried out alternately by means of setting a voltage, from beginning of the charging operation for a transition target voltage lower than the final target voltage, and, after the transition target voltage is reached, then carrying out control in such a manner that the charging operations of the first and second chargers may be carried out alternately by means of setting a time.
